(19) United States
(12) Patent Application Publication
(10) Pub. No.: US 2011/0051719 A1
(43) Pub. Date: Mar. 3, 2011

(54) PROVIDING A CALL SERVICE IN A COMMUNICATION NETWORK

(76) Inventors: Han-Wook Jung, Seoul (KR); Sang-Ho Koh, Seoul (KR); Seung-Hoon Beak, Seoul (KR); Young-Chae Lim, Seoul (KR); Sang-Chul Kim, Seoul (KR); Hyun-Ik Lee, Seoul (KR); Won-Chul Kim, Seoul (KR); Kyoung-Jin Moon, Seoul (KR); Joon-Ho Lee, Seoul (KR)

(21) Appl. No.: 12/869,181

(22) Filed: Aug. 26, 2010

(30) Foreign Application Priority Data
Aug. 28, 2009 (KR) 10-2009-0080354

(51) Int. Cl. H04M 3/48; H04L 12/66

(52) U.S. Cl. 370/352; 379/211.02

(57) ABSTRACT

Methods and systems for providing company call service in wireless and wired integrated network are provided. For example, a call between an employee's wireless device and a client's device can be connected while indicating the employee's wired telephone number as a caller's telephone number. When an employee is receiving a call, one example is to call an employee's wired device first, and if there is no response, employee's wireless device may be called subsequently. In another example, employee's wired and wireless device may be called simultaneously.

### CLAIM OF PRIORITY

This application claims the benefit of Korean Patent Application No. 10-2009-0080354 filed on Aug. 28, 2009, which is incorporated herein by reference in its entirety.

### BACKGROUND

The present disclosure relates to call services in a communication network, and more particularly, to methods and apparatus for providing company call services in an integrated wireless and wired network.

As wireless communication technology develops, most people now have a wireless communication device and use wireless communication services, such as a mobile voice or video call. Along with such developments in wireless communication technology, wired communication technology is also developing as an Internet Protocol (IP) based Next Generation Network (NGN). As such, wireless and wired communication technologies are now being integrated based on IP technology. Accordingly, employees' personal wireless communication devices are commonly used for business purposes even though companies provide wired telephones to their employees.

However, employees may not be willing to use their personal wireless devices for business purposes because of: 1) the cost of telephone bills for business-related usages that may have to be covered by the employees; 2) the possible invasion of privacy by exposing their personal wireless telephone numbers; or 3) the inconvenience of receiving irrelevant business calls after moving to other departments or jobs.

On the other hand, there are also several issues for using employees' personal wireless communication devices for business purposes from the companies' point of view. For example, if a company covers its employees' wireless telephone bills, the company may also end up covering employees' personal usage of wireless devices. Additionally, the company risks losing its current clients because the clients' calls will remain to be directed to the employee's personal wireless device even after the employee leaves the company. Particularly, since the clients' information is stored in the previous employee's personal wireless device, the successor would not be able to immediately and efficiently resume the previous employee's work.

### SUMMARY

It has been realized that what is needed in order to solve this problem is to provide a method and system for providing company call service in an integrated wireless and wired network.

In accordance with the disclosure, the method may include steps of receiving a request from a wireless device of an employee to connect to a client's device; retrieving a wired telephone number of the employee from an address book database; and connecting the client's device and the wireless device of the employee, whereby the wired telephone number being indicated as a caller's telephone number.

In another embodiment of the disclosure, the method may include steps of receiving a signal having a wired telephone number of an employee as a recipient's telephone number; calling a wired device of the employee, the wired device having the wired telephone number; retrieving a wireless telephone number of the employee from an address book database if no response is received from the wired device; and calling a wireless device of the employee, the wireless device having the wireless telephone number.

In another embodiment of the disclosure, the method may include steps of receiving a signal having a wired telephone number of an employee as a recipient's telephone number; retrieving a wireless telephone number of the employee from an address book database; calling a wireless device and a wired device of the employee simultaneously, wherein: the wired device having the wired telephone number, and the wireless device having the wireless telephone number; receiving a response from at least one of the wireless and the wired device; and connecting the responded device with a caller's device.

In accordance with the disclosure, the system may include an address book database for storing a wireless telephone number and a wired telephone number for a corresponding employee; and a management server for connecting a wireless device of the employee to a client's device upon receipt of a request from the wireless device to connect to the client's device, wherein: the management server being capable of retrieving the wired telephone number of the employee from the address book database, and the wired telephone number being indicated as a caller's telephone number.

In another embodiment of the disclosure, the system may include an address book database for storing a wireless telephone number and a wired telephone number for a corresponding employee; and a management server for connecting the employee with a client upon receipt of a request including the wired telephone number of the employee, wherein: the wired telephone number being indicated as a recipient's telephone number, the management server calls a wired device of the employee, and if no response is received, the management server retrieves the wireless telephone number of the employee from the address book database and calls a wireless device of the employee.

In another embodiment of the disclosure, the system may include an address book database for storing a wireless telephone number and a wired telephone number for a corresponding employee; and a management server for connecting the employee with a client upon receipt of a request including the wired telephone number of the employee, wherein: the wired telephone number being indicated as a recipient's telephone number, the management server retrieves the wireless telephone number of the employee from the address book database and calls a wireless device and a wired device of the employee simultaneously, and if a response is received from at least one of the wireless device and the wired device, the management server connects the responded device with a caller's device.

The disclosure in this specification can be implemented to realize one or more of the following advantages. For example, the disclosure can be implemented to allow a company to effectively manage its important client information by processing employees' calls with a central system. Employees may also use the company's wired telephone numbers as their account telephone numbers instead of using their personal wireless telephone number for business purposes. This allows employees' privacy to be protected, and the client information can effectively be maintained with the company even after employees leave.

The disclosure can also be implemented to effectively reduce cost of telecommunication bills by processing outgoing calls with the central system, which allows personal and business calls to be distinguished.

This general and specific disclosure can be implemented using an apparatus, a method, a system, or any combination of an apparatus, methods, and systems. The details of one or more implementations are set forth in the accompanying drawings and the description below. Further features, aspects, and advantages will become apparent from the description, the drawings, and the claims.

### BRIEF DESCRIPTION OF THE DRAWINGS

FIG. 1 illustrates a company call service system according to one embodiment of the present disclosure.

FIG. 2 illustrates an example of a flow chart describing a method of call connection between employees in the system presented in FIG. 1.

FIG. 3 illustrates another example of a signal flow chart describing a method of call connection between employees in the system presented in FIG. 1.

FIG. 4 illustrates a company call service system according to another embodiment of the present disclosure.

FIG. 5 illustrates an example of a flow chart describing a method of call connection from an employee to a client in the system presented in FIG. 4.

FIG. 6 illustrates a company call service system according to another embodiment of the present disclosure.

FIG. 7 illustrates an example of a flow chart describing a method of call connection from a client to an employee in the system presented in FIG. 6.

FIG. 8 illustrates another example of a flow chart describing a method of call connection from a client to an employee in the system presented in FIG. 6.

### DETAILED DESCRIPTION OF THE DISCLOSURE

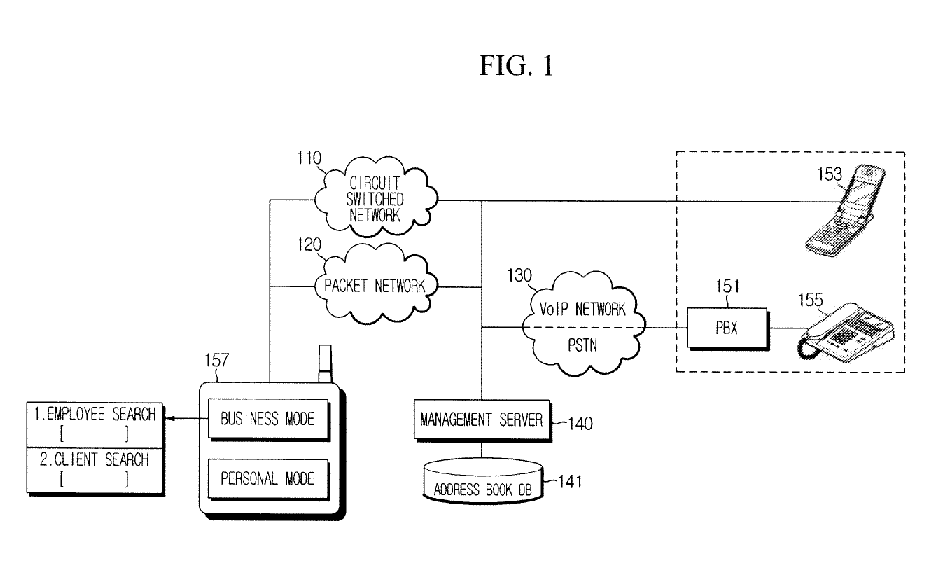

FIG. 1 illustrates a company call service system according to one embodiment of the present disclosure. According to the company call service system described in FIG. 1, the system may include a functional unit, such as a management server 140 and various networks 110, 120, 130 that connect the management server 140 with wired and wireless devices 153, 155, 157. The management server 140 is coupled to a database, such as an address book database 141. The management server 140 communicates with the wireless devices 153, 157 via circuit switched network 110 that provides wireless telephone service and packet network 120 that provides data service. The management server 140 communicates with the wired device 155 via Voice over Internet Protocol (VoIP) network and/or Public Switched Telephone Network (PSTN) 130. Detailed description of such networks 110, 120, 130 is omitted herein since such networks are well known in the art.

For the exemplary system described in FIG. 1, the wireless communication devices 153, 157 and the wired communication device 155 are assumed to be used by employees of a company. It is also assumed that the wireless device 157 is used by employee A and that the wireless device 153 and the wired device 155 are used by employee B. Also, the system is assumed to illustrate an example of the call connection attempt between employees A and B.

The employees' wireless devices 153, 157 may have client programs that may retrieve information in the address book database 141 by connecting with the management server 140 via the packet network 120. The client program can also request a call connection. Call connections using the client programs are described as business mode, and the connections without using the client programs are described as personal mode.

If the wireless device 157 is connected to the management server 140 via the packet network 120 using the client program, a screen is displayed on the wireless device 157 to retrieve telephone numbers of employees and/or clients, as described in FIG. 1. When the user enters the name of the recipient, the client program sends this information to the management server 140.

The management server 140 manages an address book by storing it in the address book database 141. The address book may include information of employees and clients, e.g., telephone numbers and email addresses. The management server 140 also stores employees' wireless telephone numbers and wired telephone numbers in the address book database 141. As such, when employee B′s name is entered at the wireless device 157, the management server 140 may retrieve the wired and/or the wireless telephone number that corresponds to the employee B′s name from the address book database 141. The management server 140 may send the retrieved number to the wireless device 157. Then, the server 140 may receive a request for a call from the wireless device 157.

When the management server 140 receives a request from employee A′s wireless device 157 to call employee B′s wired device 155, the management server calls employee A′s wireless device 157 via circuit switched network 110 and simultaneously calls employee B′s wired device 155 via wired communication networks 130 and PBX 151. If there is no response from employee B′s wired device 155, the management server 140 retrieves employee B′s wireless telephone number from the address book database 141. Then, the server 140 calls employee B′s wireless device 153 via circuit switched network 110 and connects employee B′s wireless device 153 with employee A′s wireless device 157.

Accordingly, although not described in FIG. 1, the management server 140 may include a search engine to retrieve information from the address book, a web service module to provide an address book search service for the wireless devices 153, 157, and a signal processing module to connect the devices 153, 155, 157 by calling them. The management server 140 may be implemented by intelligent network apparatus or a company's intra private network. The management server 140 may include a computer-readable medium containing instructions that, when executed, perform the foregoing methods. The implementations, however, are not limited to the above examples.

In another embodiment of the disclosure, when the management server 140 receives a request from employee A′s wireless device 157 to call employee B′s wireless device 153, the management server 140 retrieves employee B′s wireless telephone number from the address book database 141 and calls employee B′s wireless device 153 and wired device 155 simultaneously. If there is a response from any one of employee B′s devices 153 and 155, the management server 140 connects the responsive device with employee A′s wireless device 157 and disconnects the call between the server 140 and the non-responsive device.

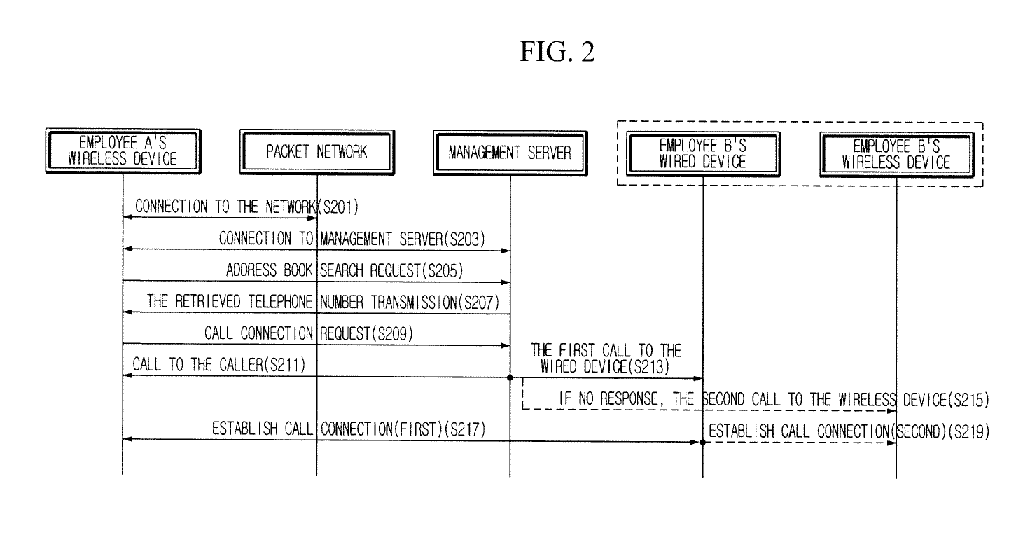

FIG. 2 illustrates an example of a flow chart describing a method of call connection between employees in the system illustrated in FIG. 1. As described in FIG. 2, employee A uses the client program on the wireless device 157. The client program establishes connection to packet network 120 (S201), then to the management server 140 via packet network 120 (S203).

As the wireless device 157 is connected to the management server 140, the server 140 sends initial screen to the wireless device 157 for an address book search. As described in FIG. 1, the initial screen includes a search menu for employees and clients. If employee A enters employee B′s name for a search, an address book search request including employee B′s name is sent to the management server 140 by the client program (S205).

Upon receipt of the request including the entered name, the management server 140 retrieves the telephone number corresponding to the entered name from the address book database 141. Then, the server 140 sends the retrieved telephone number to employee A′s wireless device 157 (S207). The client program of the wireless device 157 displays the retrieved telephone number and a call button. If employee A selects the call button to call the device with the retrieved telephone number, i.e., the wired device 155, the client program sends a request to the management server 140 to call the wired device 155 (S209).

Upon receipt of the request, the management server 140 simultaneously calls the wireless device 157 via circuit switched network 110 and employee B′s wired device 155 via wired communication networks 130 and PBX 151 (S211, S213). Alternatively, calls to the wireless device 157 and the wired device 155 are made at different times. For example, employee A′s wireless device 157 may be called first, and if there is a response from employee A′s device, employee B′s wired device 155 may be called subsequently while the call to employee A is put on hold. Order of calls may vary depending on the types of services and implementations of the present disclosure.

If a response is received from employee B′s wired device 155, the management server 140 connects the wired device 155 to employee A′s wireless device 157 (S217).

If there is no response from employee B′s wired device 155, the management server 140 retrieves the telephone number of employee B′s wireless device 153 from the address book database 141, and then the server 140 calls employee B′s wireless device 153 (S215). Preferably, the server 140 calls employee B′s wireless device 153 if there is no response from the wired device 155 for a predetermined period of time. If there is a response from the wireless device 153, the server 140 connects employee B′s wireless device 153 to employee A′s wireless device 157 (S219).

As described above, a company can manage an address book for its employees and connect calls between the employees through a central server. This allows the company to effectively manage the cost of business-related telephone bills. Also, callers can avoid having to call recipients' multiple devices separately because the wireless device 153 is called subsequently when there is no response received from the wired device 155.

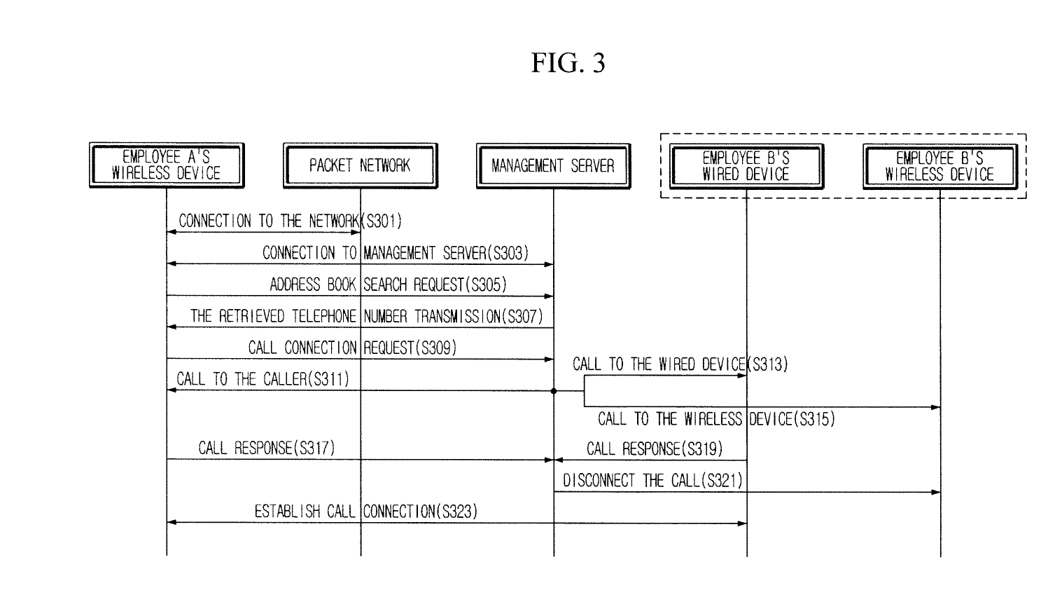

FIG. 3 illustrates another example of a flow chart describing a method of call connection between employees in the system presented in FIG. 1. Employee A uses a client program on the wireless device 157. The client program establishes connection to packet network 120 (S301), and connection to the management server 140 via packet network 120 (S303).

As the wireless device 157 is connected to the management server 140, the server 140 sends initial screen to the wireless device 157 for an address book search. As described in FIG. 1, the initial screen includes a search menu for employees and clients. If employee A enters employee B′s name for a search, an address book search request including employee B′s name is sent to the management server 140 by the client program (S305).

Upon receipt of the request including the entered name, the management server 140 retrieves the telephone number corresponding to the entered name from the address book database 141. Then, the server 140 sends the retrieved telephone number to employee A′s wireless device 157 (S307).

The client program of the wireless device 157 displays the retrieved telephone number and a call button. If employee A selects the call button to call the device with the retrieved telephone number, i.e., the wired device 155, the client program sends a request to the management server 140 to call the wired device 155 (S309).

Upon receipt of the request, the management server 140 retrieves the telephone number of employee B′s wireless device from the address book database 141. Then, the server 140 calls employee A′s wireless device 157 via circuit switched network 110 (S311). Also, the server 140 calls employee B′s wired device 155 via wired communication networks 130 and PBX 151 (S313), while simultaneously calling employee B′s wireless device 153 via circuit switched network 110 (S315). Accordingly, employee B′s wired and wireless devices 153 and 155 receive calls simultaneously.

If responses are received from employee A′s wireless device 157 and employee B′s wired device 155 (S317, 319), the management server 140 connects the call between those devices 155 and 157 (S323) and disconnects the call between the server 140 and employee B′s wireless device 153 (S321).

If responses are received from employee A′s wireless device 157 and employee B′s wireless device 153 but no response is received from employee B′s wired device 155, the management server 140 connects the call between those devices 153, 157 and disconnects the call between the server 140 and employee B′s wired device 155.

Calls to employee A′s device and employee B′s devices may be made at different times. For example, employee A′s wireless device 157 may be called first, and if there is a response from employee A′s device, employee B′s wired device 155 and wireless device 153 may be called subsequently while the call to employee A is put on hold. Order of calls may vary depending on the types of services and implementations of the present disclosure.

As described above, a company can manage an address book database for its employees and connect calls between the employees through a central server, such as the management server 140. This allows the company to effectively manage the cost of business-related telephone bills. Also, callers do not have to call recipients' multiple devices separately because the wireless device 153 is automatically called when there is no response received from the wired device 155.

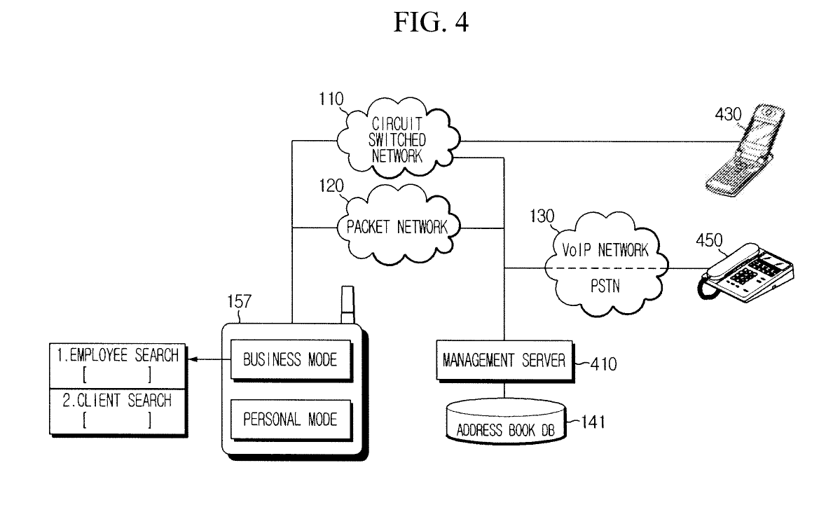

FIG. 4 illustrates a call service system according to another embodiment of the present disclosure. Elements that are common in FIG. 1 and FIG. 4 have the same functionality, and thus a detailed description will be omitted for those common elements.

For the system described in FIG. 4, the wired device 157 is assumed to be a first user's device, and the wireless device 430 and the wired device 450 are assumed to be a second user's device. The first user may be an employee of a company and the second user may be a client of the company. An example of a call connection attempt from the employee's wireless device 157 to the client's devices 430 and 450 is explained below.

In order to call a client, the employee runs a client program at the wireless device 157, so that the wireless device 157 may be connected to a functional unit, such as the management server 410, via packet network 120. Then, as described in FIG. 1, the initial screen is displayed on the employee's wireless device 157 to provide a search menu. When the employee enters a client's name for a search, the client program sends this information to the management server 410.

With the information received from the client program, the management server 410 retrieves the telephone number of the client's wired device and/or wireless device from a database, such as the address book database 141. Then, the management server 410 may send the retrieved number to the wireless device 157.

When the management server 410 receives a call request from employee's wireless device 157 to call the client's device, the server 410 calls employee's wireless device 157 via circuit switched network 110. The server 410 also calls the client's wireless devices 430 via circuit switched network 110. Alternatively or in addition to that, the server 410 calls the client's wired device 450 via wired communication networks 130. The server 410 retrieves the telephone number of the employee's wired device (not shown) from the address book database 141 and send that number to the client's devices 430 and 450 as a caller's telephone number, so that the retrieved employee's wired telephone number can be indicated on the client's devices 430, 450 as a caller's telephone number. In other words, when calling client's devices 430, 450, the management server 410 replaces employee's wireless telephone number with the wired telephone number so that the wired telephone number may be displayed as a caller's telephone number.

Accordingly, although not described in FIG. 4, the management server 410 may include a replacement module that can send an employee's wired telephone number as a caller's telephone number when the employee calls a client using a wireless device.

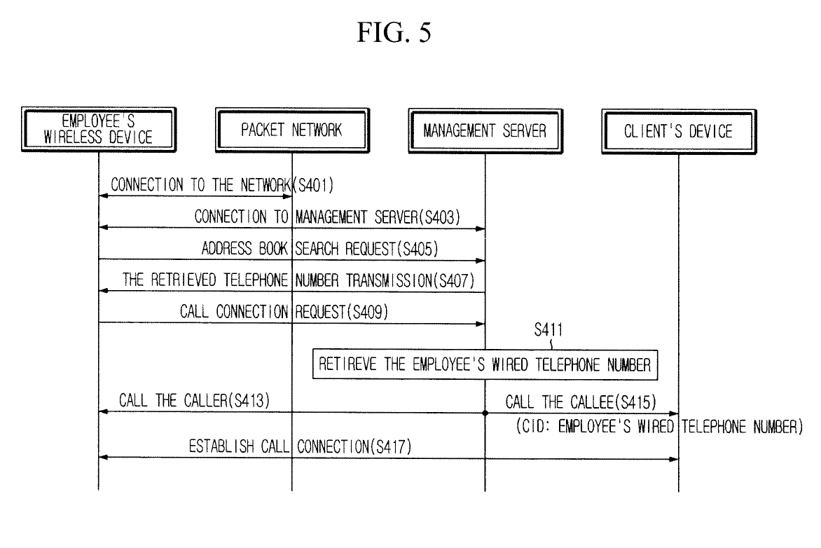

FIG. 5 illustrates an example of a flow chart describing a method of call connection from an employee to a client in the system presented in FIG. 4. As described in FIG. 5, the employee uses the client program on the wireless device 157. The client program establishes connection to packet network 120 (S401), and connection to the management server 410 via packet network 120 (S403).

As the wireless device 157 is connected to the management server 410, the server 410 sends an initial screen on the wireless device 157 for an address book search. As described in FIG. 4, the initial screen includes a search menu for employees and clients. If the employee enters a client's name for a search, an address book search request including the client's name is sent to the management server 410 by the client program (S405).

Upon receipt of the request including the entered name, the management server 410 retrieves the telephone number that corresponds to the entered name from the address book database 141. Then, the server 410 sends the retrieved telephone number to the wireless device 157 (S407). The client program of the wireless device 157 displays the retrieved telephone number and a call button.

If the employee selects the call button to call the device with the retrieved telephone number, the client program of the wireless device 157 sends a request to the management server 140 to call the above selected telephone number (S409).

The management server 410 verifies if the call request signal is for a client rather than another employee, and retrieves the employee's wired telephone number from the address book database 141 (S411).

Then, the management server 410 calls the wireless device 157 via circuit switched network 110 and simultaneously calls the client's wireless device 430 and/or wired device 450 via circuit switched network 110 and/or wired communication networks 130 (S413, S415). Then, the management server 410 connects the call between the employee and the client (S417).

When calling the client's devices 430 and/or 450, the management server 410 sends the employee's wired telephone number, retrieved from the address book database 141 at 5411, rather than the employee's wireless telephone number, to be indicated as a caller's number.

The calls to the wireless device 157 and the client's devices 430, 450 may be made at different times. For example, the employee's wireless device 157 may be called first, and the client's devices 430, 450 may be called subsequently while the call to the employee is put on hold. If there is a response from the client's device, then the call between the employee and the client can be connected.

As described above, a company can manage an address book of its employees and clients and connect calls between an employee and a client through a central server. This allows the company to minimize the risk of losing client information after employees leave the company. Also, the company may better protect its employees' privacy because the employees' telephone numbers at work (in most cases, wired devices) are sent to the clients, even when the employees call their clients using their personal mobile devices.

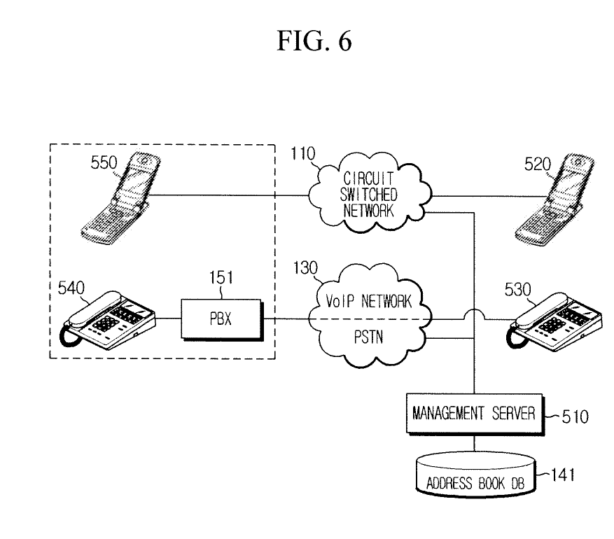

FIG. 6 illustrates a call service system according to another embodiment of the present disclosure. Elements that are common in FIG. 1 and FIG. 4 have the same functionality, and thus a detailed description will be omitted for those common elements.

In the embodiment described in FIG. 6, the wireless device 520 and the wired device 530 are assumed to be a first user's devices, and the wireless device 550 and the wired device 540 are assumed to be a second user's devices. The first user may be a client of a company and the second user may be an employee of the company. An example of a call connection attempt from the first user's devices 520, 530 to the second user's wired device 540 in the system of FIG. 6 will be explained below.

If the client calls the employee's wired telephone number from the client's device 520 or 530, the client's device sends a call request signal to the communication network 110 or 130. Then, a controller (not shown) of the communication network 110 or 130 checks whether the recipient's telephone number is registered for a company call service. If the recipient's telephone number is registered for the company call service, the controller of the communication network 110 or 130 routes the call request signal to a functional unit, such as the management server 510.

The management server 510 retrieves a caller's telephone number from the signal received from the client's device and stores the retrieved number in the address book database 141. If the retrieved caller's number has already been stored in the database 141, the management server 510 may merely register the number in the incoming call log without adding new contact information. If the retrieved caller's number has not yet been stored in the database 141, the management server 510 may store the number in the unidentified client list of the address book database 141 so that the called employee may later edit and store the information as new client information.

Upon receipt of the signal including the recipient's telephone number, the management server 510 attempts to connect with the employee's wired device 540 via wired communication network 130 by dialing the recipient's number, i.e., the employee's wired telephone number. If no response is received from the employee's wired device 540, the management server 510 attempts to connect with the employee's wireless device 550 via circuit switched network 110, using the employee's wireless telephone number retrieved from the address book database 141. As such, the server 510 connects the client's device 520 or 530 to the employee's device 540 or 550 that has responded.

In another embodiment of the disclosure, when the management server receives a signal including the telephone number of the employee's wired device 540, the management server 510 retrieves the employee's wireless telephone number from the address book database 141. Then, the server 510 calls the employee's wired device 540 and the employee's wireless device 550 simultaneously. If there is a response from at least one of employee's devices 540 and 550, the server 510 connects the responsive device with the client's device 520 or 530 and disconnects the call between the server 140 and the non-responsive device.

When the management server 510 receives the signal from the client's device, the server 510 retrieves the caller's telephone number from the signal and retrieves the caller's information that corresponds to the retrieved telephone number from the address book database 141. Then, the server 510 sends the retrieved caller's information to the employee's devices 540 and/or 550. For example, the caller's name or an employee's memo about the caller that were stored in the database 141 may be sent to and displayed at the employee's devices 540 and/or 550, as well as the caller's telephone number.

Accordingly, the management server 510 allows the employee to effectively deal with the calling client by sending the information about the client stored in the address book database 141. Specifically, the server 510 may retrieve the client's information upon receipt of the signal from the client and provide the information to the employee's devices 540 and/or 550 when directing the call to the devices.

Accordingly, although not described in FIG. 6, the management server 510 may include a client telephone registration module that can retrieve client's telephone number and store it in the address book database 141. The server 510 may also include a caller's information searching module that retrieve the caller's information from the address book database 141 by using the retrieved caller's telephone number.

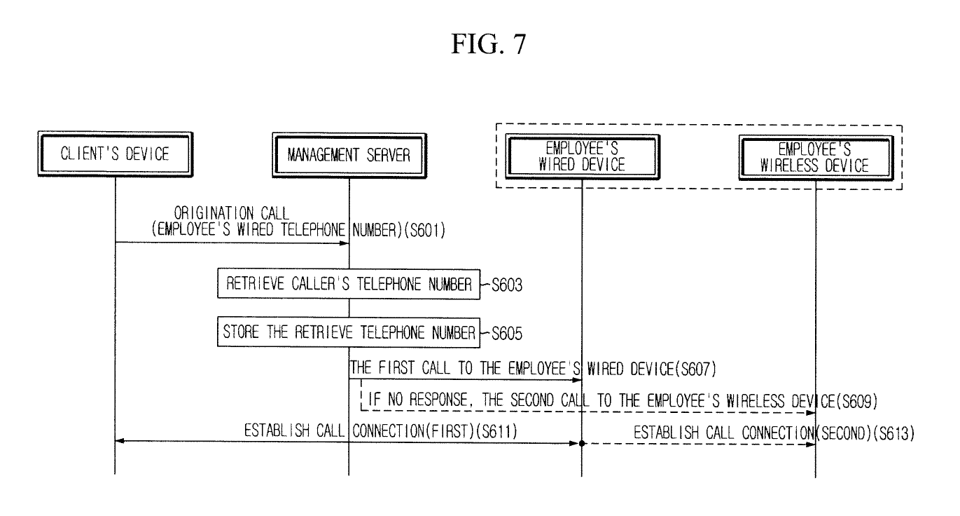

FIG. 7 illustrates an example of a flow chart describing a method of call connection from a client to an employee in the system presented in FIG. 6. As described in FIG. 7, in order to call an employee, a client may enter the employee's wired telephone number on the client's device 520 or 530 and select a call button, thereby generating a call request signal. When the call request signal is sent to communication network 110 or 130 from the client's device 520 or 530, the controller of the communication network 110 or 130 checks whether the recipient's number included in the signal is registered for a company call service. If so, the controller of the communication network 110 or 130 sends the signal to the management server 510 (S601).

The management server 510 retrieves a caller's telephone number from the signal sent from the client's device 520 or 530 (S603) and stores the retrieved number in the address book database 141 (S605). The server 510 may either register the number in the incoming call log or in a folder for unregistered clients so that the called employee may later store the telephone number as new client information.

Then, the management server 510 calls the employee's wired device 540 via wired communication networks 130 and PBX 151 (S607). If there is a response from the employee's wired device 540, the server 510 connects the call between the client's device 520 or 530 and the employee's device 540 (S611).

However, if there is no response from the employee's wired device 540 for a predetermined period of time, the server 510 calls the employee's wireless device 550 via circuit switched network 110, using the employee's wireless telephone number retrieved from the address book database 141 (S609). If a response is received from the employee's wireless device 550, the server 510 sets up the call between the client's device 520 or 530 and the employee's wireless device 550 (S613).

With this illustrative implementation of the present disclosure, employees may use the company's wired telephone numbers for business purposes, and clients may use the employees' wired telephone numbers to contact them. Particularly, clients may contact the employees without knowing their wireless telephone numbers because the management server 510 attempts to call the employees' wired devices first and then attempts to call the employees' wireless devices if there is no response from the wired devices. Accordingly, the employees may better protect their privacy because their personal wireless telephone numbers are not exposed. Also, the company may minimize the risk of losing client information after employees leave the company because call logs including clients' telephone numbers are recorded when the clients attempt to contact employees.

Although the example of the flow chart of FIG. 7 describes that employee's wired device 540 is called first and the wireless device 550 is called subsequently if there is no response from the wired device 540, there may be alternatives. For example, as described in FIG. 3, the employee's wired device 540 and wireless device 550 may be called simultaneously after retrieving the employee's wireless number from the address book database 141. If there is a response from any one of employee's devices 540 and 550, the server 510 may connect the responsive device with the client's device 520 or 530 and disconnect the call between the server 140 and the non-responsive device.

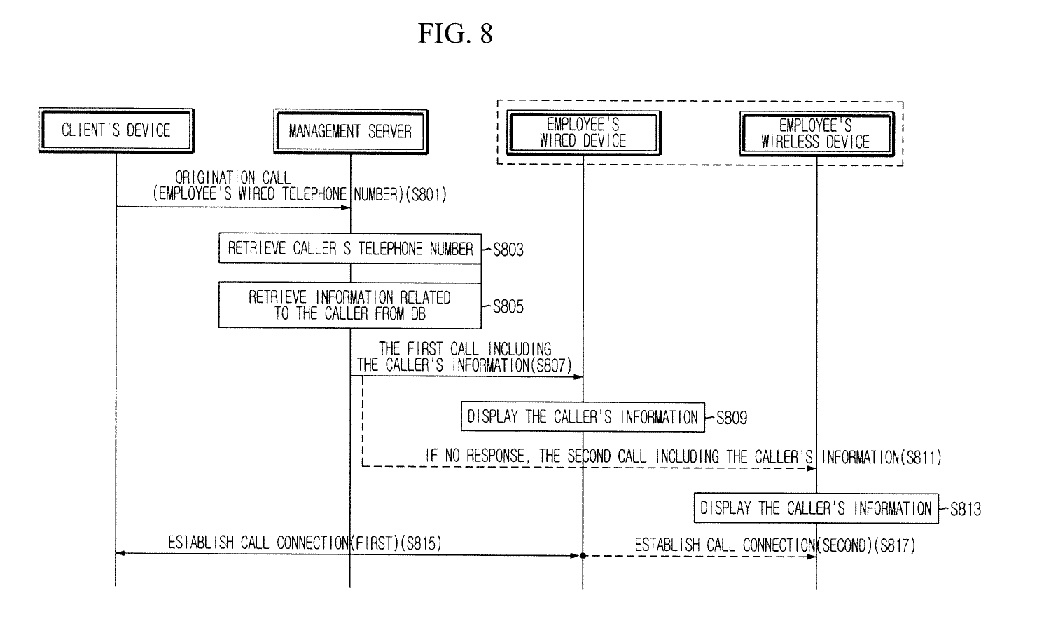

FIG. 8 illustrates another example of a flow chart describing a method of call connection from a client to an employee in the system presented in FIG. 6. As described in FIG. 8, in order to call an employee, a client enters the employee's wired telephone number on the communication device 520 or 530 and selects a call button, sending a call request signal. When the call request signal is sent to communication network 110 or 130 from the client's device 520 or 530, the controller of the communication network 110 or 130 checks whether the recipient's number included in the signal is registered for a company call service. If so, the controller of the communication network 110 or 130 sends the signal to the management server 510 (S801).

As the management server 510 receives the call request signal, the server 510 retrieves the caller's telephone number from the signal (S803). The management server 510 then retrieves information related to the caller (i.e., the client) from the address book database 141 using the caller's telephone number (S805). The information related to the caller may be the name of the caller or a memo prepared by an employee about the caller.

Then, the management server 510 calls the employee's wired device 540 via wired communication networks 130 and PBX 151, and also sends the information related to the caller to the employee's wired device 540 (S807). Accordingly, the caller's information may be displayed on the employee's wired device 540, and this allows the employee to have the caller's information even if the relevant information was not stored in the employee's wired device 540 (S809). If there is a response from the employee's wired device 540, the server 510 connects the client's device 520 or 530 to the employee's wired device 540 (S815).

However, if there is no response from the employee's wired device 540 for a predetermined period of time, the management server 510 calls the employee's wireless device 550 via circuit switched network 110, using the employee's wireless telephone number retrieved from the address book database 141. Here, the server 510 also sends the retrieved caller's information to the employee's wireless device 550 (S811). Accordingly, the caller's information may be displayed on the employee's wireless device 550, and this allows the employee to have the caller's information even though the relevant information was not stored in the wireless device 550 (S813). If there is a response from the employee's wireless device 550, the server 510 connects the client's device 520 or 530 to the employee's wireless device 550 (S817).

As described above, clients may reach the employees' wireless communication devices by calling the employees' wired telephone numbers. Also, the management server 510 allows the employees to effectively deal with the clients by sending the clients' information stored in the address book database 141 when directing the calls to the employees. Specifically, the server 510 retrieves clients' information upon receipt of the call request signals from the clients and provides the relevant information to the employees' devices 540 and 550.

Although the example of the flow chart of FIG. 8 describes that employee's wired device 540 is called first and the wireless device 550 is called subsequently if there is no response from the wired device 540, there may be alternatives. For example, as described in FIG. 3, calls to employee's wired device 540 and wireless device 550 can be made simultaneously after retrieving the employee's wireless number from the address book database 141. If there is a response from any one of employee's devices 540 and 550, the server 510 may connect the responsive device with the client's device 520 or 530 then, disconnect the call between the server 140 and the non-responsive device.

The methods described above as various embodiments of the present disclosure may be implemented as a set of computer-executable instructions and stored in a computer readable medium such as CD-ROM, RAM, ROM, Floppy disk, Hard drive, or magneto-optical disc.

Although a number of embodiments of the present disclosure have been disclosed herein, the above description is merely illustrative. It will be understood that various modifications may be made without departing from the spirit and scope of the claims. Accordingly, other embodiments are within the scope of the following claims.

What is claimed is:

1. A method for providing a call service in a communication network, the method comprising:
on at least one functional unit,
receiving a request from a first user's wireless communication device to connect to a second user's communication device;
retrieving a telephone number of the first user's wired communication device from a database; and
setting up a call between the first user's wireless communication device and the second user's communication device, wherein the telephone number of the first user's wired communication device is sent to the second user's communication device as a caller's telephone number.

2. The method of claim 1, wherein the request from the first user is received through a packet network.

3. The method of claim 1, further comprising sending information related to the second user to the first user's wireless communication device.

4. The method of claim 1, wherein the step of setting up the call between the first user's wireless communication device and the second user's communication device comprises:
calling the first user's wireless communication device;
calling the second user's communication device; and
connecting the first user's wireless communication device and the second user's communication device.

5. The method of claim 1, wherein the functional unit is a management server, wherein the first user is an employee of a company, and wherein the second user is a client of the company.

6. A method for providing a call service in a communication network, the method comprising:
on at least one functional unit,
receiving a request from a first user's communication device to connect to a second user's wired communication device;
calling the second user's wired communication device; and
if no response is received from the second user's wired communication device, calling the second user's wireless communication device.

7. The method of claim 6, further comprising:
retrieving information related to the first user from a database based on a telephone number of the first user's communication device; and
sending the information related to the first user to at least one of the second user's wired communication device and the second user's wireless communication device.

8. The method of claim 7, wherein the step of calling the second user's wireless communication device comprises searching a database for a telephone number of the second user's wireless communication device.

9. The method of claim 7, further comprising storing a telephone number of the first user's communication device in a database.

10. The method of claim 7, wherein the functional unit is a management server, wherein the first user is a client of a company, and wherein the second user is an employee of the company.

11. A method for providing a call service in a communication network, the method comprising:
on at least one functional unit,
receiving a request from a first user's communication device to connect to a second user's wired communication device; and
simultaneously calling the second user's wired communication device and the second user's wireless communication device.

12. The method of claim 11, further comprising, if a response is received from one of the second user's wireless communication device and the second user's wired communication device, disconnecting the call to the non-responsive device.

13. The method of claim 11, wherein the step of calling the second user's wireless communication device comprises searching a database for a telephone number of the second user's wireless communication device.

14. The method of claim 11, further comprising storing a telephone number of the first user's communication device in a database.

15. The method of claim 11, further comprising:
retrieving information related to the first user from a database based on a telephone number of the first user's communication device; and
sending the information related to the first user to at least one of the second user's wired communication device and the second user's wireless communication device.

16. The method of claim 11, wherein the functional unit is a management server, wherein the first user is a client of a company, and wherein the second user is an employee of the company.

17. An apparatus comprising:
a first functional unit configured to receive a request from a first user's wireless communication device to connect to a second user's communication device;
a second functional unit configured to retrieve a telephone number of the first user's wired communication device from a database; and
a third functional unit configured to set up a call between the first user's wireless communication device and the second user's communication device, wherein the telephone number of the first user's wired communication device is sent to the second user's communication device as a caller's telephone number.

18. The apparatus of claim 17, wherein the request from the first user is received through a packet network.

19. The apparatus of claim 17, further comprising a fourth functional unit configured to send information related to the second user to the first user's wireless communication device.

20. The apparatus of claim 17, wherein the third functional unit is further configured to:
call the first user's wireless communication device;
call the second user's communication device; and
connect the first user's wireless communication device and the second user's communication device.

21. The apparatus of claim 17, wherein the apparatus is a management server, wherein the first user is an employee of a company, and wherein the second user is a client of the company.

22. An apparatus comprising:
a first functional unit configured to receive a request from a first user's communication device to connect to a second user's wired communication device;
a second functional unit configured to call the second user's wired communication device; and
a third functional unit configured to call the second user's wireless communication device if no response is received from the second user's wired communication device.

23. The apparatus of claim 22, further comprising:
a fourth functional unit configured to retrieve information related to the first user from a database based on a telephone number of the first user's communication device; and
a fifth functional unit configured to send the information related to the first user to at least one of the second user's wired communication device and the second user's wireless communication device.

24. The apparatus of claim 23, wherein the third functional unit is further configured to search a database for a telephone number of the second user's wireless communication device.

25. The apparatus of claim 23, further comprising a sixth functional unit configured to store a telephone number of the first user's communication device in a database.

26. The apparatus of claim 23, wherein the apparatus is a management server, wherein the first user is a client of a company, and wherein the second user is an employee of the company.

27. An apparatus comprising:
a first functional unit configured to receive a request from a first user's communication device to connect to a second user's wired communication device; and
a second functional unit configured to simultaneously call the second user's wired communication device and the second user's wireless communication device.

28. The apparatus of claim 27, wherein the second functional unit is further configured to, if a response is received from one of the second user's wireless communication device and the second user's wired communication device, disconnect the call to the non-responsive device.

29. The apparatus of claim 27, wherein the second functional unit is further configured to search a database for a telephone number of the second user's wireless communication device.

30. The apparatus of claim 27, further comprising a third functional unit configured to store a telephone number of the first user's communication device in a database.

31. The apparatus of claim 27, further comprising:
a fourth functional unit configured to retrieve information related to the first user from a database based on a telephone number of the first user's communication device; and
a fifth functional unit configured to send the information related to the first user to at least one of the second user's wired communication device and the second user's wireless communication device.

32. The apparatus of claim 27, wherein the apparatus is a management server, wherein the first user is a client of a company, and wherein the second user is an employee of the company.

33. A system for providing a company call service in a wireless and a wired integrated network, the system comprising:
an address book database for storing a wireless telephone number and a wired telephone number for a corresponding employee; and
a management server for connecting a wireless device of the employee to a client's device upon receipt of a request from the wireless device to connect to the client's device,
wherein:
the management server being capable of retrieving the wired telephone number of the employee from the address book database, and
the wired telephone number being indicated as a caller's telephone number.

34. The system of claim 33, further comprising:
service means for processing a connection of the wireless device via a packet network and providing an address book searching tool in a form of web services; and
means for searching a telephone number from the address book database,
whereby the telephone number corresponds to a key word inputted in the address book searching tool.

35. The system of claim 34, the management server receives a signal capable of confirming whether the telephone number is selected at the wireless device of the employee.

36. The system of claim 33, the management server being capable of calling the wireless device and the client's device individually to connect the wireless device and the client's device.

37. The system of claim 34, the management server being capable of calling the wireless device and the client's device individually to connect the wireless device and the client's device.

38. A system for providing a company call service in a wireless and a wired integrated network, the system comprising:
an address book database for storing a wireless telephone number and a wired telephone number for a corresponding employee; and
a management server for connecting the employee with a client upon receipt of a request including the wired telephone number of the employee,
wherein:
the wired telephone number being indicated as a recipient's telephone number,
the management server calls a wired device of the employee, and
if no response is received, the management server retrieves the wireless telephone number of the employee from the address book database and calls a wireless device of the employee.

39. The system of claim 38, further comprising registration means for storing a caller's telephone number in the address book database if the request is from a caller other than the employee, wherein the management server being capable of retrieving the caller's telephone number from the request.

40. The system of claim 38, further comprising means for retrieving caller's information from the address book database by using a caller's telephone number, wherein the caller's information being included in calls to the employee.

41. A system for providing a company call service in a wireless and a wired integrated network, the system comprising:
an address book database for storing a wireless telephone number and a wired telephone number for a corresponding employee; and
a management server for connecting the employee with a client upon receipt of a request including the wired telephone number of the employee,
wherein:
the wired telephone number being indicated as a recipient's telephone number,
the management server retrieves the wireless telephone number of the employee from the address book database and calls a wireless device and a wired device of the employee simultaneously, and
if a response is received from at least one of the wireless device and the wired device, the management server connects the responded device with a caller's device.

42. The system of claim 41, the management server disconnects a call to the non-responsive device when the response is received from at least one of the wireless and the wired device.
